(19) United States
(12) Patent Application Publication
(10) Pub. No.: US 2009/0220207 A1
(43) Pub. Date: Sep. 3, 2009

(54) Systems and Methods for Playing Video

(75) Inventors: Jules May, Angus (GB); Barry Merrick, Cambridgeshire (GB)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignee: ANT SOFTWARE LIMITED, Cambridge, Cambridgeshire (GB)

(21) Appl. No.: 12/096,124

(22) PCT Filed: Dec. 5, 2006
(86) PCT No.: PCT/GB2006/050427

§ 371 Date: Oct. 16, 2008

(30) Foreign Application Priority Data
Dec. 5, 2005 (GB) 0524747.3

(51) Int. Cl. H04N 5/91; H04N 7/16; H04N 7/025

(52) U.S. Cl. 386/68; 386/108; 725/153; 725/32; 386/E05.024

(57) ABSTRACT

The invention generally relates to the field of digital playback and especially to operation of “trickplay” features such as fast-forward and rewind, more particularly to the invention relates to playback of an auxiliary video stream during trickplay of a standard digital video stream. Embodiments of the invention are useful in digital video players and recorders. A system for playing stored video data, the system having a rapid play or rewind mode, the system comprising: means for detecting operation of said rapid play or rewind mode; and means for outputting supplementary program material during said operation of said rapid play or rewind mode. Preferably the system selects a video stream which is configured so that it plays at a substantially normal rate in a forward direction when output by a video player operating in a rapid play or rewind mode.

The invention generally relates to the field of digital playback and especially to operation of “trickplay” features such as fast-forward and rewind, more particularly to the invention relates to playback of an auxiliary video stream during trickplay of a standard digital video stream. Embodiments of the invention are useful in digital video players and recorders.

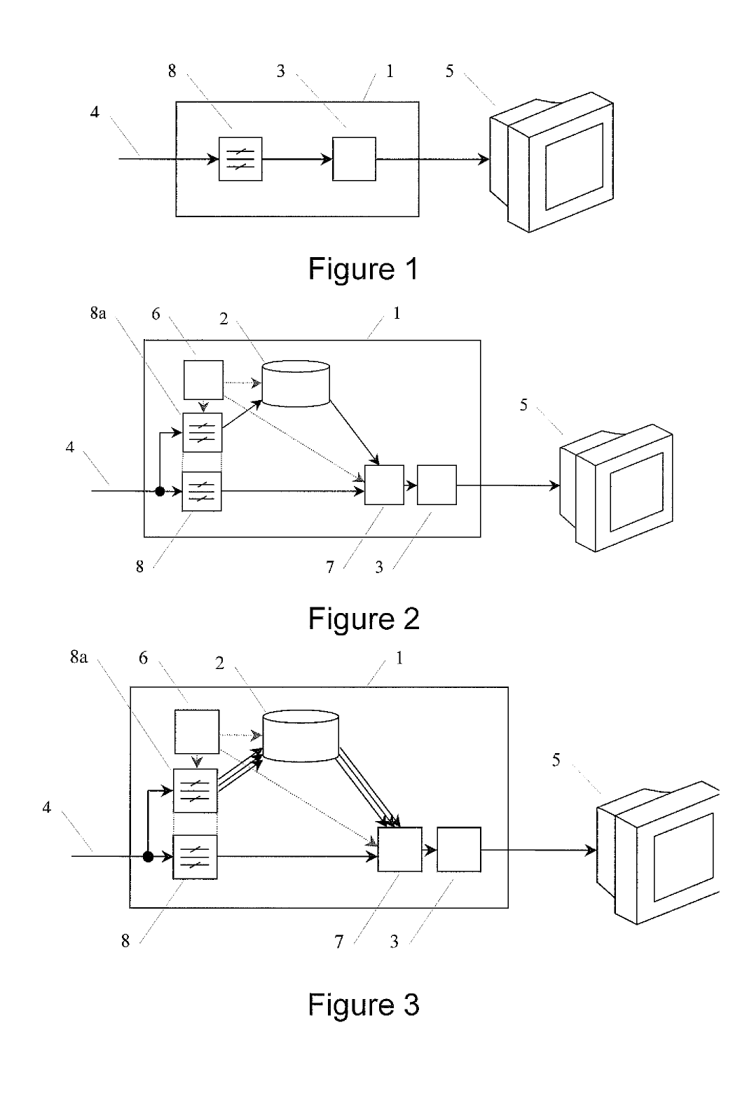

When Digital TV transmissions began using satellite and cable broadcasts, the model was a simple analogue of traditional TV receivers. FIG. 1 shows the most basic configuration of a STB. A dedicated device (set-top box, or STB, 1) contains an elementary stream selector 8 which selects an elementary stream from a multiplexed transmitted data stream 4, and digital decoder 3 which creates a moving image suitable for display on a domestic TV set 5. With few exceptions, the broadcast model was also an analogue of traditional broadcasts: a series of identifiable elementary streams, each carrying programme material interspersed with announcements and advertising.

Today's STBs are more sophisticated. FIG. 2 shows a hard-disk recorder STB. Additionally to the basic STB it contains a hard-disk or other recording means 2, which can be used to record transmissions for later playback, or for pausing live transmissions. Through suitable control means 6 and switching means 7, such recordings can be played back in fast-forward or rewind modes, when searching for a particular moment, or for bypassing adverts or announcements. Specifically, the recording means 2 records an elementary stream selected from the multiplexed transmitted data stream 4 (using either the existing selection means 8, or an additional selection means 8a as shown in FIG. 2), and (either at the same time, or subsequently) the switching means 7 directs to the decoding means 3 either a selected elementary stream or a recorded data stream (or parts thereof) from the recording means 2.

For the viewer, the ability to bypass interruptions is a great benefit. But to the broadcaster, it's a problem: the advertisers are paying for viewers to see their adverts, and the broadcaster wants his customers to see his messages. Simply preventing trickplay through adverts is not an option, because it means that all interruptions must be viewed in full when searching at high speed through a lengthy programme. Other similar conflicts are to be found in non-broadcast situations. For-rent DVDs frequently contain trailers for upcoming releases. To prevent users skipping through the trailers (as they want) the DVD publishers suppress the fast-forward and programme-skip functions, forcing every viewer to sit through every trailer on each viewing (which they hate!).

It would therefore be desirable to provide to the user the benefits of trickplay of recorded material, without losing the benefits to the broadcaster of advertising and announcements.

Background art is described in US 2004/0103429, US 2005/0097599, US 2005/0091682, US 2004/0034874, EP 1289290 and U.S. Pat. No. 6,909,837.

### SUMMARY OF THE INVENTION

According to a first aspect of the invention there is therefore provided a system for playing stored video data, the system having a rapid play or rewind mode, the system comprising: means for detecting operation of said rapid play or rewind mode; and means for outputting supplementary program material during said operation of said rapid play or rewind mode. Preferably the system selects a video stream which is configured so that it plays at a substantially normal rate in a forward direction when output by a video player operating in a rapid play or rewind mode.

Embodiments of the system may comprise a video disc player, for example a DVD (Digital Versatile Disc) player and/or a so-called Personal Video Recorder (PVR). In this context a PVR may be taken as a system which is able to record real time broadcast video to allow pause and/or rewind of the broadcast material whilst it is being watched and/or subsequent playback (timeshift). The rapid play mode of embodiments of the system provides playback at a faster than real-time speed; the rewind mode may be at any speed including, for example, unity (backwards real-time) and less.

Other embodiments of the system may be implemented on a video-on-demand system, where the high speed video streams are sent from a server. More generally internet streaming protocols may additionally or alternatively be employed together with a remote server.

In some preferred embodiments the stored (or otherwise provided) video data comprises a plurality of video data streams configured for playback at a plurality of different rates. For example MPEG (Moving Picture Expert Group) stream typically has header information including frame rate data, and the frames typically include a time code. Furthermore, because an MPEG video stream can be identified (the separate streams are numbered) the normal rate of playback for the stream can be determined from a frequency of packets for a particular stream whether or not frame rate and/or time code data is also present. It will be recognised that these techniques may be employed for MPEG data including, but not limited to, MPEG 1, MPEG 2 and MPEG 4, as well as to other types of digital video data.

In preferred embodiments the system includes means for selecting a stream responsive to a selected rapid play or rewind mode, in particular so that when played using the selected mode, the video appears as normal. In particular preferred embodiments of the system are configured to play the supplementary program material forwards when the selected playing mode comprises a rewind mode. This may be achieved by including time-reversed video data within the MPEG or other digital video data stream.

The skilled person will appreciate that although, in some preferred embodiments, the supplementary program material comprises video material (which term as used here generally but not necessarily also implies the presence of corresponding audio), other types of supplementary program material may also be employed including, but not limited to, still picture data, interactive program data, for example in a web page format, audio data, film preview data, news headline data and the like.

In embodiments for use with broadcast video the system also includes a receiver for receiving, and decoding, the broadcast video data and a recorder for recording at least part of the received video stream, for example in a substantially conventional manner. The supplementary program material may then comprise part of the same overall stream (multiplex) of broadcast video data. Thus, in particular, the system may be configured to receive all overall video stream comprising a plurality of interleaved streams with different video rates—that is configured for playback at different rates and/or optionally in a time-reversed direction. Thus the system preferably comprises a de-interleaver for separating these interleaved video streams for later selection in response to the selected replay mode (rapid play, rewind or pause as described further below).

In some further preferred embodiments the system also includes a means for detecting a marker of supplementary program material in a received video stream, for example a means of detecting an advertising marker which is included in a broadcast video stream. The means for outputting the supplementary program material may then be responsive to detection of such a marker. For example, in some embodiments of the system the supplementary material may be downloaded, for example overnight, and then this material may be played during a rapid play, rewind or pause operation of the player. In some other embodiments, however, detection of the marker together with selection of a play mode, in particular a rewind mode, may be employed to select the broadcast stream as a source of the supplementary program material. More particularly still, when operation of a rewind operation is detected shortly after a supplementary program material (advertising) marker has been received, then the supplementary material (advert) received in real-time going forwards in time from the operation of the rewind control may be played during the rewind operation, or at least during the first part of the rewind operation. To facilitate such a mode of operation a broadcaster may include an advertising or other marker shortly after an event where a user might wish to operate a rewind or pause control, for example after a goal in a football match. Then in one of the video streams within the broadcast video stream, but preferably not that carrying the football match itself, the supplementary material would be provided for replay by the system in the event that a user chose to pause and/or rewind the watched broadcast video stream, for example in this particular example, to pause or rewind the events leading to the goal.

Thus in a further aspect the invention provides a system for playing stored video data, the system having a pause mode, the system comprising: means for detecting operation of said pause mode; and means for outputting supplementary program material during said pause mode; and wherein said supplementary program material comprises one or more of a pausable frame of a received video stream, a selected stream of broadcast video, and a portion of a received video stream following an advertising marker.

As previously mentioned, as well as being employed in systems for receiving broadcast video, for example Personal Video Recorders, the above-described systems may also be incorporated into a Video Disc Player such as a DVD player (which here includes variants aid developments of the DVD standard).

In a further aspect the invention provides a method for playing stored video data using a system with a rapid play or rewind mode, the method comprising: detecting operation of said rapid play or rewind mode; and outputting supplementary program material during said operation of said rapid play or rewind mode.

The invention further provides a method for playing stored video data using a system with a pause mode, the method comprising: detecting operation of said pause mode; and outputting supplementary program material during said operation of said pause mode; and wherein said supplementary program material comprises one or more of a pausable frame of a received video stream, a selected stream of broadcast video, and a portion of a received video stream following an advertising marker.

The invention further provides processor control code to implement the above-described systems and methods, in particular on a data carrier such as a disk, CD- or DVD-ROM, programmed memory such as read-only memory (Firmware), or on a data carrier such as an optical or electrical signal carrier. Code (and/or data) to implement embodiments of the invention may comprise source, object or executable code in a conventional programming language (interpreted or compiled) such as C, or assembly code, code for setting up or controlling an ASIC (Application Specific Integrated Circuit) or FPGA (Field Programmable Gate Array), or code for a hardware description language such as Verilog (Trade Mark) or VHDL (Very high speed integrated circuit Hardware Description Language). As the skilled person will appreciate such code and/or data may be distributed between a plurality of coupled components in communication with one another.

In a still further aspect the invention provides a digital video signal comprising data for a plurality of video streams, at least one of said streams comprising video data for non-real-time playback.

Preferably one or more such non real-time streams are included, for example a stream comprising data for playback as real-time video when stored and replayed by a video player operating in a rapid play mode and/or a stream comprising data for playback as real-time video when stored and replayed by a video player operating in a reverse play or rewind mode. Preferably the digital video signal comprises an MPEG compatible signal, for example a signal compatible with MPEG 1 (in particular the ISO/IEC 11172 set of standards), 2 (in particular the ISO/IEC 13818 set of standards), and/or 4 (in particular the ISO/IEC 14496 set of standards).

The above-described digital video signal may be provided on a carrier medium such as a disc or an optical or electrical signal carrier, or as a broadcast (radio frequency) digital video signal.

According to a further aspect of the present invention, there is provided a method of outputting an alternate video stream responsive to a user selecting a pause or rewind mode, the method comprising receiving a multiplexed video stream comprising a first video stream and an alternate video stream, outputting the first video stream, determining when the user selects the pause or rewind mode, and outputting the alternate video stream responsive to said determining.

Preferably the first video stream comprises a broadcast television channel, which may comprise one or more scheduled television programmes, optionally comprising one or more advertisements interspersed with the scheduled television programmes. Preferably the second video stream comprises one or more advertisements, and/or announcements and/or other interruptions. Preferably the method comprises switching streams when the user has selected the pause or rewind mode and an advertisement is about to start on the alternate video stream.

The method may be used in a television receiver, a set top box or a digital video player such as a DVD player. Furthermore, the multiplexed video stream may be carried as a signal, such as an MPEG-1, 2 or 4 signal, or on a medium such as an optical disc or a memory card.

These and other aspect of the invention will now be further described, by way of example only, with reference to the accompanying figures in which:—

FIG. 1 shows a simple example of a Set Top Box (STB);

FIG. 2 shows an example of an STB incorporating a hard disc video recorder/player;

FIG. 3 shows an example of an STB according to an embodiment of an aspect of the present invention;

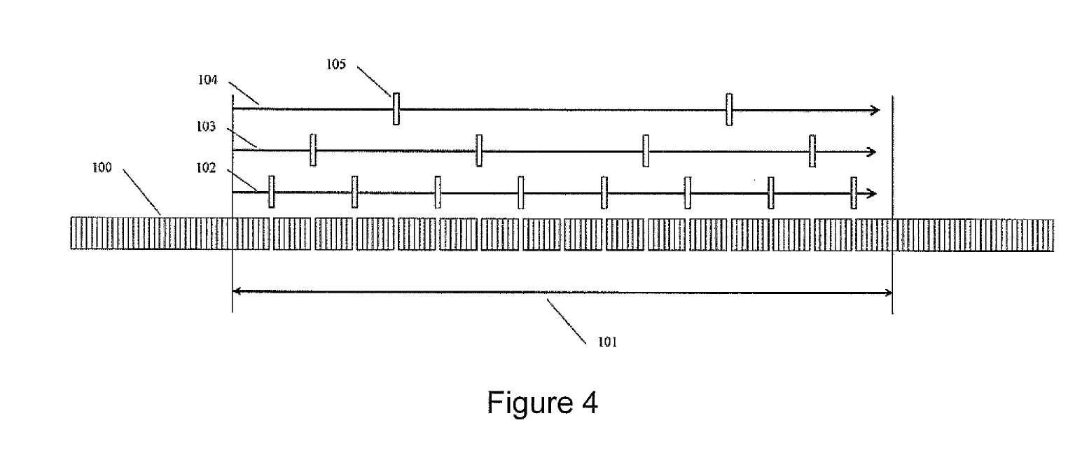

FIG. 4 shows a representation of multiple, concurrent, non-real time elementary streams combined with the original programme material;

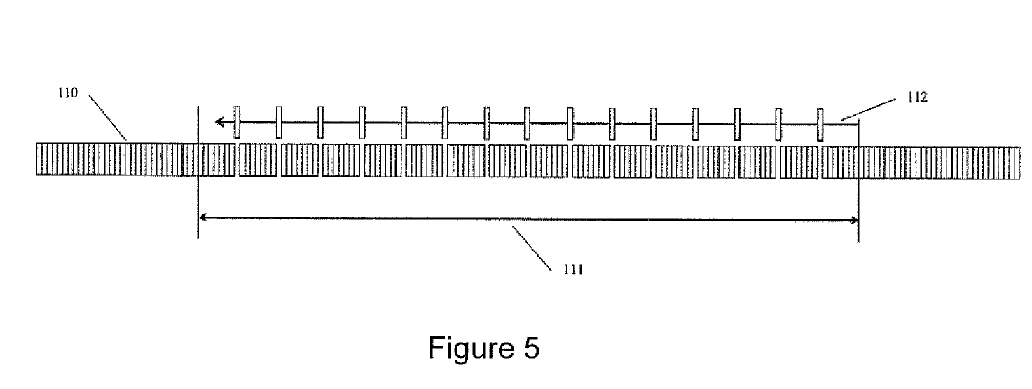

FIG. 5 shows a representation of a single, reversed elementary stream combined with the original programme material;

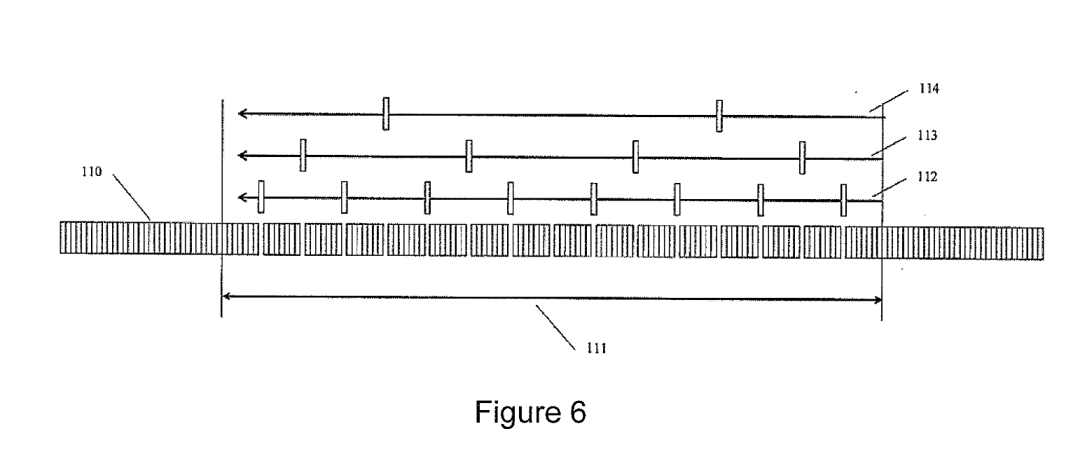

FIG. 6 shows a representation of multiple concurrent reversed elementary streams combined with the original programme material; and

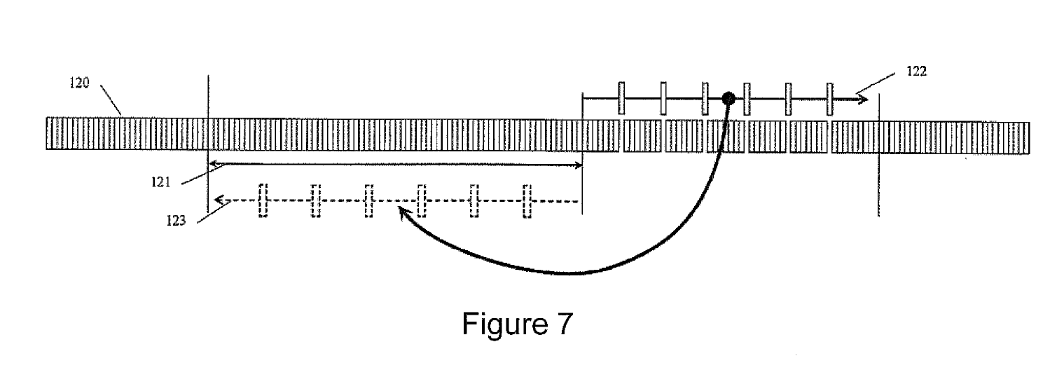

FIG. 7 shows a representation of a single forward elementary stream which is intended for replay during rewind combined with the original programme material.

According to a preferred embodiment of the present invention, as shown in FIG. 3 there is provided a STB 1 configured analogously to the conventional box in which the recording and playback means 2 records and replays a multiplicity of elementary streams which have been transmitted with different non-realtime “densities”, the selection means 8a selects a multiplicity of data elementary streams for recording, and the switching means 7 selects one elementary stream from the multiplicity of recorded elementary streams or from a transmitted elementary stream, at whichever density is appropriate for the present trickplay mode.

In a first embodiment, as shown in FIG. 4, the STB records programme material 100 such as a movie which comprises a number of data packets 105. The programme is interspersed by a series of 150-second advertising breaks 101—which would typically contain five 30 second adverts. The packets representing the advertising breaks are augmented with additional packets containing data representing elementary streams depicting an auxiliary 30-second advert 102, a 10-second advert 103, and a 5-second advert 104, all multiplexed with the original data stream as shown, and arranged to occupy the entire 150-second slot. During normal viewing, or normal playback, the five conventional adverts are shown normally, and the other adverts are not seen at all. During 5× playback only the auxiliary 30 s advert will be shown (the original five will not be seen), at 15× playback only the 10 s advert will be shown, and at 30× playback only the 5 s advert will be shown. Note that the adverts are shown at, or close to, normal viewing speed, not at the high-speed playback multiple.

As the viewer fast-forwards through his recording, all the durations are compressed as he would expect. However, when the advertising break is encountered, the most appropriate-duration advert is selected for presentation. This ensures the viewer sees the message without disturbing his or her search.

The advantage to the advertiser, particularly in programme material which is likely to be saved for long periods, is that even though the message is short, it will be viewed many times.

In a second embodiment as shown in FIG. 5, a stream of packets representing a pre-recorded sporting event 110 is augmented with an elementary stream 112 containing data representing a short advert of typically 5 s, which is recorded in reverse frame order, and multiplexed with the programme elementary stream such that it overlaps some significant action 111 such as the few seconds before a goal. When the viewer watches the broadcast normally, no advert is visible. Using a recording STB the viewer may rewind the action to see the goal again, and during the rewind process it will be the advert which is shown rather than backward-running footballers. The end of the advert cues the viewer to resume playback of the action. Again, even though the advert is short, it may be seen many times.

The duration of the advert and the duration of the action are in the general case unrelated. Rewinding through the action will play the advert at the most appropriate multiple, and when the advert is finished the playback will revert to the backward-running game.

Naturally, it is possible to combine this embodiment with the previous, and record a selection of differing speed-multiple reverse adverts. FIG. 6 depicts this case.

In a third embodiment as shown in FIG. 7 a live sporting event 120 is augmented with data packets comprising an elementary stream 122 which represents a short advert, which is recorded in normal frame order such that it overlaps and/or succeeds a significant event 121, such as a goal. When the viewer watches the broadcast normally, no advert is visible. If the user rewinds the action, the advert is shown during the rewind as at 123. The advert data can be taken either directly from the transmitted data (if the rewind is taking place during the transmission of the advert) or from the recorded data. In subsequent rewinds, the recorded version of the advert is shown. This embodiment is useful in live sporting events where the significance of a particular action is not known until after the action has completed. It is also valuable in that it does not take bandwidth away from the action of interest, but instead uses bandwidth from the aftermath of the action, which is much less valuable.

In a fourth embodiment the advertiser rents an advertising space in a programme for a limited period of time. A sporting event is augmented with an elementary stream in accordance with one of the preceding embodiments representing an advert for a limited-time offer, such as travel to later rounds in the competition. Several methods are possible.

In a first method, two adverts are mixed into the transmission stream in accordance with any of the preceding embodiments. Additionally, a flag which identifies that an alternative advert is available is mixed into the stream. When an advert is presented, the flag is consulted, and if it is effective (for example, it is in-date) one of the streams is presented, otherwise the other stream will be presented. Optionally, when the flag becomes ineffective, the data representing the first advert can be erased from the recorder.

In a second method, only one advert is mixed into the transmission stream in accordance with any of the preceding embodiments. Additionally a flag which identifies that an alternative advert is available is mixed into the stream. When the advert is presented, the flag is consulted, and if the flag is effective (for example, it is in date) the stream is taken from another live, or nearly live transmission stream. If the flag is not effective, the advert will be taken from the recording. Additionally the online stream may, on expiry, revoke the flag so the online stream will not be consulted again. In the third method, only one advert is mixed into the transmission stream. No additional flag is recorded. On expiry of the advert, a replacement advert is sent to the recorder, which will be recorded in place of the original, obliterating the original. The replacement can be sent at any time, even when the recording is not being used, in order to exploit periods of low bandwidth.

This embodiment permits the broadcaster to sell the same advertising slot to many different advertisers, and the advertising message remains appropriate to the viewers as the recording ages.

No doubt many other effective alternatives will occur to the skilled person. Examples include news headline summaries embedded within more comprehensive news broadcasts, special cut-down versions of movies intended for rapid or time-limited viewing, and pause-mode screensavers such as depictions of fish-tanks and fireplaces.

It will be understood that the invention is not limited to the described embodiments and encompasses modifications apparent to those skilled in the art lying within the spirit and scope of the claims appended hereto.

1. A digital video signal comprising data for a plurality of video streams, at least one of said streams comprising video data for non-real-time playback.

2. A digital video signal as claimed in claim 1 wherein said at least one stream comprising video data for non-real-time playback comprises data for playback as real time video when stored and replayed by a video player operating in a rapid play mode.

3. A digital video signal as claimed in claim 1 wherein said at least one stream comprising video data for non-real-time playback comprises data for playback as real time video when stored and replayed by a video player operating in reverse play mode.

4. A digital video signal as claimed in claim 1 wherein said digital video signal comprises an MPEG compatible signal.

5. A carrier medium readable by a video player, said carrier medium carrying a digital video signal as claimed in claim 1.

6. A system for playing stored video data, the system having a rapid play or rewind mode, the system comprising:
means for detecting operation of said rapid play or rewind mode; and
means for outputting supplementary program material during said operation of said rapid play or rewind mode.

7. A system as claimed in claim 6 wherein said stored video data comprises a plurality of video data streams configured for replay at a plurality of different rates; wherein the system has a plurality of said rapid play modes of different speeds; and wherein the system further comprises means for selecting a said stream responsive to a speed of said operated rapid play mode such that said selected stream has a speed suitable for output using said rapid play mode.

8. A system as claimed in claim 6 wherein said outputting means is configured to output said supplementary program material to play in a forwards direction when said operated mode comprises a rewind mode.

9. A system as claimed in claim 6 wherein said stored video data and said supplementary program material comprise part of the same stream of broadcast video data, the system further comprising a receiver for receiving said broadcast video stream and a recorder for recording at least parts of said received stream.

10. (canceled)

11. A system as claimed in claim 6, the system further comprising a receiver for receiving a broadcast video stream and a recorder for recording at least parts of said received stream, the system further comprising:
means for detecting a marker of supplementary program material in a said received video stream; and
wherein said means for outputting of said supplementary program material is responsive to said marker detection.

12. A system as claimed in claim 11 wherein said supplementary program material comprises a part of a said broadcast stream following said marker; and
wherein said outputting means is configured to output said received supplementary material in a forward play direction during operation of said rapid play or rewind mode in a rewind mode.

13. A video disc player incorporating a system as claimed in claim 6.

14. A system for playing stored video data, the system having a pause mode, the system comprising:
means for detecting operation of said pause mode; and
means for outputting supplementary program material during said pause mode; and
wherein said supplementary program material comprises one or more of a pausable frame of a received video stream, a selected stream of broadcast video, and a portion of a received video stream following an advertising marker.

15. A method for playing stored video data using a system with a rapid play or rewind mode, the method comprising:
detecting operation of said rapid play or rewind mode; and
outputting supplementary program material during said operation of said rapid play or rewind mode.

16. A method for playing stored video data using a system with a pause mode, the method comprising:
detecting operation of said pause mode; and
outputting supplementary program material during said operation of said pause mode; and
wherein said supplementary program material comprises one or more of a pausable frame of a received video stream, a selected stream of broadcast video, and a portion of a received video stream following an advertising marker.

17. A carrier carrying computer program code to, when running, implement the method of claim 16.

18. A method of outputting an alternate video stream responsive to a user selecting a pause or rewind mode, the method comprising:
receiving a multiplexed video stream comprising a first video stream and an alternate video stream;
outputting the first video stream;
determining when the user selects the pause or rewind mode; and
outputting the alternate video stream responsive to said determining.

19. A method according to claim 18 wherein the first video stream comprises a broadcast television channel.

20. A method according to claim 18 wherein the alternate video stream comprises one or more advertisements.

21. A method according to claim 20 wherein said determining further comprises determining when an advertisement is about to start on the alternate video stream, and wherein said alternate video stream outputting is conditional on said user selecting said pause or rewind mode and said advertisement being about to start.

22. An apparatus comprising means for implementing the method of claim 18.

23. A carrier carrying the multiplexed video stream of claim 18.

24. A system as claimed in claim 7, wherein said stored video data and said supplementary program material comprise part of the same stream of broadcast video data, the system further comprising a receiver for receiving said broadcast video stream and a recorder for recording at least parts of said received stream.

25. A system as claimed in claim 24 wherein said different rate video streams comprise interleaved streams within said broadcast video stream; the system further comprising a de-interleaver for said interleaved video streams.

26. A carrier carrying computer program code to, when running, implement the method of claim 16.
